(19) United States
(12) Patent Application Publication
(10) Pub. No.: US 2024/0133187 A1
(43) Pub. Date: Apr. 25, 2024

(54) TAPING KNIFE HANDLE, AND TAPING KNIFE PROVIDED WITH SUCH A HANDLE

(71) Applicant: ÉTABLISSEMENTS PIERRE GRÉHAL ET CIE SA, BAILLET EN FRANCE (FR)

(72) Inventor: Lionel DELESTRE, Beaumont-sur-Oise (FR)

(21) Appl. No.: 17/768,277

(22) PCT Filed: Oct. 13, 2020
(86) PCT No.: PCT/EP2020/078885

§ 371 Date: Apr. 11, 2022

(30) Foreign Application Priority Data
Oct. 13, 2019 (FR) 1911416

(51) Int. Cl. E04F 21/16; B25G 1/10

(52) U.S. Cl. CPC E04F 21/163; B25G 1/102

(57) ABSTRACT

The invention relates to a taping knife handle (100) comprising a gripping part (110) connected to a blade attachment part (130) by a central part (120). The griping part (110) has a convex upper face (111) for receiving the palm and fingers of the user's hand. According to the invention, the convex curved upper face (111) is connected to the central part (120) by means of: ⋅ an engagement region (112) having a front convex curved engagement face (114) directly connected to a concave curved engagement face (121) located at the front of the central part (120), and ⋅ a lever region (113) comprising a convex lower lever face (115) located under the convex upper face (111) and connected, by a bent region (117), to a concave bearing face (122) located at the rear of the central part (120).

The invention relates to a coating knife handle.

The conventional coating knives have a cylindrical handle fixed to a blade substantially at right angles to the free edge of the blade. In this case, the handle is grasped “with the whole hand”, that is to say that the fingers and the thumb are wound in opposition around the handle.

Then the blade is applied with force against a surface to apply and smooth the coating. The blade must exhibit sufficient flexibility to bend in order to apply the coating without scraping it from the face and sufficient rigidity for the coating to be pressed against the surface.

With this type of coating knife, the user can hold the handle very strongly without tiring, but the application of the coating is not uniform over the entire width of the blade, particularly a very wide blade (greater than 25 cm).

One refinement consists in fixing a handle parallel to the blade.

In this case, the coating knife is grasped by pinching the handle between the fingers. The document FR2327374, which describes such a coating knife, can for example be cited.

This type of handle has the advantage of allowing the handle to be manufactured with a profile which can be cut to the desired length. It is thus possible to manufacture coating knives of great width, which allows for faster and more uniform work, because the application force is transmitted over the entire width of the blade.

However, the coating knife of the document FR2327374 is highly impractical, because all the compression force to be transmitted to the coating is generated by the pinching of the handle between the fingers of the hand, which makes the operation painful and tiring. To avoid that, this document illustrates a position in which the handle is held in the palm of the hand, but this position requires the wrist to be bent strongly when applying the coating, which results in pain with use.

The documents DE1845335 and EP2137364 propose a notable enhancement of the coating knife of the preceding document, by providing a handle provided with an engagement part and a lever part.

While these handles have provided satisfaction for many years, it has been found that their hand grip was not always entirely satisfactory during use.

Thus, the handle of the document DE1845335 slips very easily from the fingers which must be pinched very strongly to hope to be able to pull the coating knife during application.

Moreover, the handle of the document EP2137364, which is illustrated in FIG. 1, also requires the user to strongly pinch the handle A with the end of the fingers B, the thumb C being hyperextended, which is tiring and uncomfortable.

Furthermore, in addition to the pinching of the handle by the fingers, the latter tire quickly, because it is them which also apply all the torsional force to apply the coating, even if the rear end D of the handle is jammed in the hollow E of the thumb.

Thus, during use, the hand tends to paralyze, and the user must stop working for the time it takes to rest.

Moreover, this very rigid type of handle requires a position of the hand very close to the surface, requiring the user to strongly break the alignment between his or her hand and his or her forearm at the wrist. The alternative is to provide a very flexible blade, but that is detrimental to the product application quality.

In the long term, this type of handle generates musculoskeletal disorders both in the fingers, but also in the wrist.

The objective of the present invention is therefore to propose an economical handle, that is to say one that can be manufactured easily in the form of a profile that is lightweight and which limits the tiring from use, while ensuring optimal application of the coating.

To do this, the invention provides a gripping part making it possible to combine the advantages of a powerful grasp of the cylindrical handles and of a uniform application of the profiled handles, while avoiding paralyzing the hand during application.

The subject of the invention is, more specifically, a coating knife handle composed of a profile extending along a longitudinal direction and comprising a gripping part linked by a central part to a fixing part for fixing an edge of a coating blade, wherein the gripping part has a convex top face intended to receive the palm and the fingers of the hand of the user. The convex curved top face is linked to the central part, on the one hand:
by an engagement zone comprising a front convex curved engagement face, against which the fingers of the user can fold, and linked directly to a concave curved engagement face situated at the front of the central part, and on the other hand,
by a lever zone comprising a convex bottom lever face situated under the convex top face, against which the thumb of the user can fold in the direction of the joint, and linked by a switchback zone to a concave bearing face situated behind the central part.

By allowing the thumb to be closed in the direction of the joint instead of being hyperextended as in the prior art, the switchback zone of the handle according to the invention allows a natural stiffening of the wrist of the user, which transfers the application force to the arm and therefore to the shoulder, which are much more resistant to tiring.

According to particular embodiments:
the convex top face can have a main radius of curvature of between 9 and 11 cm, preferably 10 cm;
the convex bottom lever face can have a radius of curvature of between 7 and 9 cm, preferably 8 cm;
the front convex curved engagement face and the concave curved engagement face can have a radius of curvature of between 0.8 and 1.2 cm;
the concave bearing face can have a radius of curvature of between 2.4 and 2.8 cm, preferably 2.6 cm;
the switchback zone can have a convex curved switchback face having a radius of curvature of between 0.2 and 0.6 cm, preferably 0.4 cm;
the convex top face can be linked to the convex bottom lever face by a convex curved bearing face having a radius of curvature of between 0.6 and 0.9 cm, preferably 0.75 cm;
seen in cross-section of the handle, the gripping part can have a median plane, passing through a middle of the front convex curved engagement face and a middle of the rear convex curved bearing face, the median plane forming an angle (a) with the reference plane; and/or
the fixing part can be extended by a compression part intended to bear against the deformable coating blade when the latter is fixed to the coating knife handle, the compression part comprising a first flat bearing surface extending in a reference plane on one side of which the compression part is located and on the other side of which the blade is located when the latter is fixed to the coating knife handle, and wherein the fixing part has, furthermore, a fixing heel secant with the reference plane and comprising a second flat fixing surface for fixing the blade, the first and the second flat surfaces forming an open angle between them, less than 179.9°, preferably less than 179.5°, advantageously between 177 and 179.5°.

Another subject of the invention is a coating knife comprising a coating knife handle as above, and a constrained flat blade fixed by force against the second flat fixing surface borne by the heel, and pressed by force against the first flat bearing surface of the compression part.

Another subject of the invention is an assembly comprising a handle as above and a fixing part for fixing an extension handle to this handle, the fixing part having a form complementing the engagement and lever zones of the handle to be able to be attached to the handle.

The above assembly can also comprise an extension handle provided with said fixing part.

Other features of the invention will be stated in the following detailed description given with reference to the attached figures, given by way of example, and which represent, respectively:

FIG. 1, a schematic profile view of a coating knife handle of the prior art and showing the position of the hand pinching with the ends of the fingers;

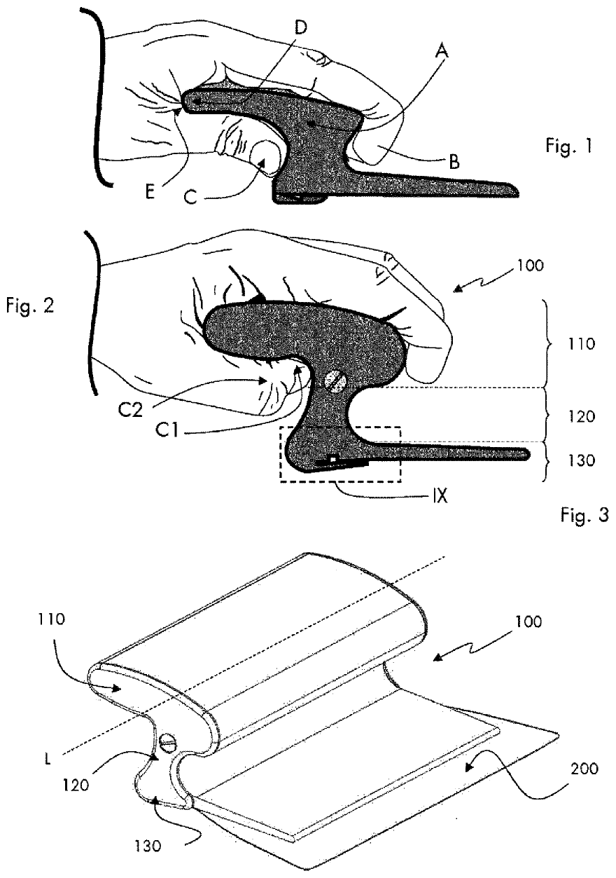

FIG. 2, a schematic profile view of a coating knife handle according to the invention and showing the position of the hand gripping with all of a hand;

FIG. 3, a perspective schematic view of the handle of FIG. 2;

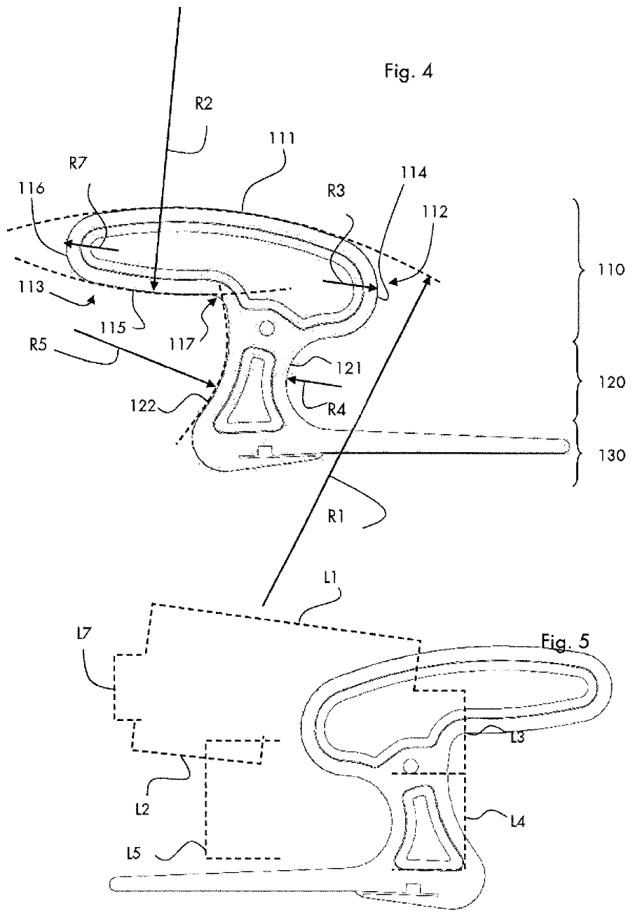

FIG. 4, a cross-sectional schematic view of the handle of FIG. 2 illustrating the radii of curvature of the handle according to the invention;

FIG. 5, a cross-sectional schematic view of the handle of FIG. 2 illustrating the dimensions and proportions of the handle according to the invention;

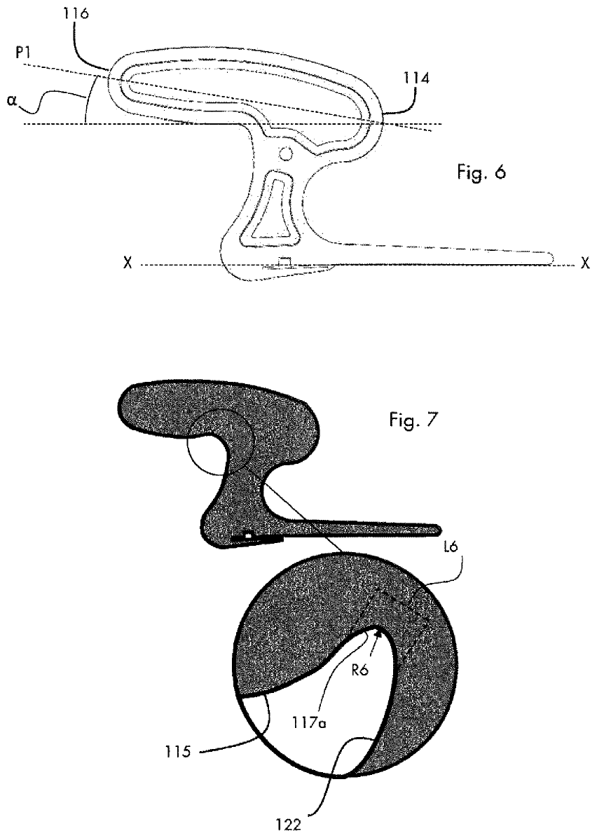

FIG. 6, a cross-sectional schematic view of the handle of FIG. 2 illustrating the inclination of the gripping part with respect to the blade fixing part of the handle according to the invention;

FIG. 7, a profile schematic view of a coating knife handle according to the invention and showing a first embodiment, enlarged, of the switchback zone;

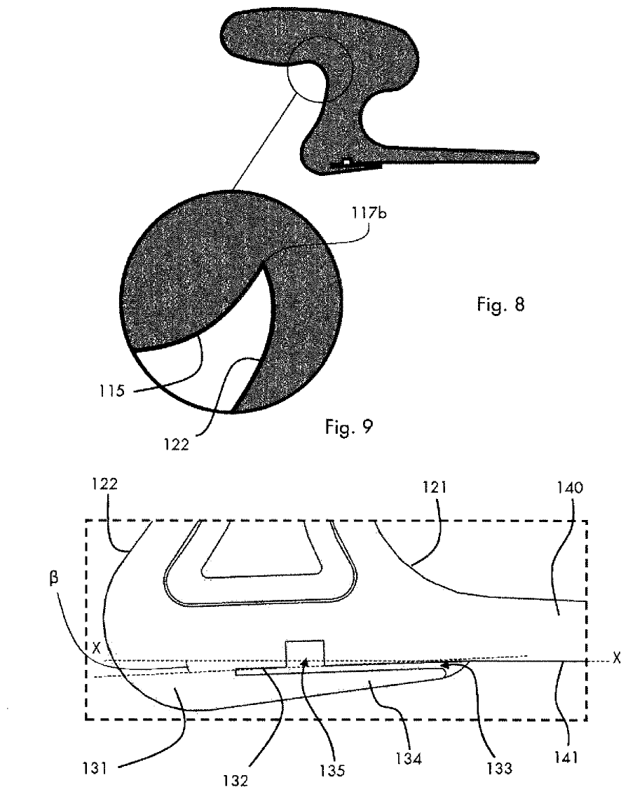

FIG. 8, a profile schematic view of a coating knife handle according to the invention and showing a second embodiment, enlarged, of the switchback zone; and

FIG. 9 a cross-sectional schematic view of a partial enlargement IX of the handle of FIG. 2 illustrating the fixing heel for fixing the blade.

By convention, hereinafter in the present description, the so-called “top” elements are those situated towards the top of the handle of FIG. 2, the so-called “front” or “distal” elements are those situated to the right of the handle of FIG. 2, that is to say toward the blade and away from the user, the so-called “rear” or “proximal” elements are those situated to the left of the handle of FIG. 2, that is to say opposite the blade and toward the user, and the so-called “bottom” elements are those situated toward the bottom of the handle of FIG. 2.

Also by convention, “curved” is understood to mean a surface formed by a circular arc.

Referring to FIGS. 2 to 6, a coating knife handle 100 according to the present invention comprises a profile extending along a longitudinal direction L (see FIG. 3). The handle 100 comprises, seen in profile, a gripping part 110 linked by a central part 120 to a fixing part 130 for fixing an edge of a coating blade 200. In other words, the handle is fixed to the blade substantially parallel to the free edge of the blade.

The form of the gripping part 110 and of the central part 120 allows the user to grasp the handle in an embrace, that is to say with the whole hand, with the fingers and the thumb folded in the direction of the joints. This effect is obtained by the gripping part 110 which has a convex curved top face 111 intended to receive the palm and the fingers of the hand of the user, and which is linked to the central part 120 by a distal engagement zone 112 and by a proximal lever zone 113.

The distal engagement zone 112 comprises a front convex curved engagement face 114, against which the ends of the fingers of the user can fold, allowing him or her to pull the coating knife during use.

The front convex curved engagement face 114 is linked directly to a concave curved face 121 situated in front of the central part 120.

Toward the rear, the convex top face 111 is also linked to the central part by the lever zone 113 which comprises a convex bottom lever face 115 situated under the convex top face 111 in the position illustrated in FIG. 2, and against which the thumb of the user can be pressed to allow the user to perform a lever movement with his or her thumb.

Advantageously, the convex curved top face 111 is linked to the convex curved bottom lever face 113 by a convex curved bearing face 116.

The convex bottom lever face 115 is linked to a concave bearing face 122 situated behind the central part 120 by a switchback zone 117.

By virtue of this switchback zone 117, the user can jam the end C1 of his or her thumb C by folding the latter in the direction of the joint C2 and not hyperextended as in the state of the art. This position allows the hand to embrace the gripping part in a very powerful and comfortable position.

Furthermore, this embracing position is highly effective since it is the powerful muscles of the forearm which grip the handle, whereas, in pinching between the ends of the fingers, it is the muscles of the hand, which are much less powerful, which grip the handle.

In addition to the specific forms (concave, convex, curved, and switchback zone), the holding and the comfort of the handle are particularly optimized for particular dimensions.

In an advantageous embodiment, the convex top face 111 has a main radius of curvature R1 of between 9 and 11 cm, preferably 10 cm, and an arc length L1 of between 5.2 cm and 5.7 cm, preferably 5.5 cm. These dimensions allow the palm of the hand to be pressed completely against the convex top face 111 and facilitate the placement of the ends of the fingers and of the thumb.

Likewise, the convex bottom lever face preferably has a radius of curvature R2 of between 7 and 9 cm, advantageously 8 cm, and an arc length L2 of between 2 cm and 3 cm, preferably 2.5 cm.

The convex curved bearing face 116 having a radius of curvature R7 of between 0.6 and 0.9 cm, preferably 0.75 cm, and an arc length L7 of between 2 cm and 2.2 cm, preferably 2.1 cm.

Toward the front, the front convex curved engagement face 113 and the concave curved engagement face 121 have a radius of curvature R3-R4 of between 0.8 and 1.2 cm, advantageously 1 cm, provided that the radius of curvature R3 of the front convex curved engagement face 113 is strictly greater by at least 0.2 cm than the radius of curvature R7 of the convex curved bearing face 116.

The radii of curvature R3 and R4 can be identical. However, the radius of curvature R3 of the convex curved face 114 can be slightly greater to soften the transition with the convex top face 111. For example, the radius of curvature R3 of the convex curved face 114 can be 1.2 cm when the radius of curvature R4 of the concave curved engagement face 121 is 1 cm.

The front convex curved engagement face 113 and the concave curved engagement face 121 have respective arc lengths L3 and L4 of between 2.5 and 3.2 cm. They can be identical or different if the radius of curvature R3 of the convex curved face 114 is slightly greater than the radius of curvature R4 of the concave curved engagement face 121.

Their respective lengths L3 and L4 can be different, which allows an inclination of the gripping part with respect to the horizontal and enhances the comfort of the user, as described hereinbelow.

In the preceding example, if the radius of curvature R3 of the convex curved face 114 is 1.2 cm and the radius of curvature R4 of the concave curved engagement face 121 is 1 cm, then the arc length L3 of the convex curved face 114 can be 3 cm and the arc length L4 of the concave curved engagement face 121 can be 2.8 cm.

That being the case, the gripping part 110 allows a powerful grasp of the hand which totally embraces this gripping part, all the fingers being folded in the directions of the joints without being hyperextended.

Preferably also, the concave bearing face 122 has a radius of curvature R5 of between 2.4 and 2.8 cm, preferably 2.6 cm, and an arc length L5 of between 2.2 and 2.6, preferably 2.4 cm.

In a preferred embodiment illustrated in FIG. 6, the radii, the lengths and the orientations of the different faces are chosen so that, seen in cross-section of the handle, the gripping part 110 has a median plane P1, passing through a middle of the front convex curved engagement face 114 and a middle of the rear convex curved bearing face 116, the median plane P1 forming an angle α with a reference plane X-X parallel to the blade 200.

In a preferred embodiment, the angle α is between 5° and 10°, advantageously 8°.

Unexpectedly, this inclination offers unequaled comfort of the hand grip of the handle 100 according to the invention, regardless of the position of application, and for most of the users.

As illustrated in FIG. 7, the switchback zone 117 according to the invention has, in an advantageous embodiment, a convex curved switchback face 117a having a radius of curvature R6 of between 0.2 and 0.6 cm, preferably 0.4 cm, and a length L6 of between 0.45 cm and 0.65 cm, preferably 0.55 cm.

This embodiment allows the end of the thumb to be comfortably housed.

Alternatively, as illustrated in FIG. 8, the switchback zone 117 can be a simple switchback point 117b between the convex curved surface 115 and the concave bearing surface 122.

The important thing is that the switchback zone 117, that is to say the transition between the convex curved surface 115 and the concave bearing surface 122, forms a hollow allowing the end of the thumb to be housed by folding the thumb in the direction of the joint, the thumb being in contact with the convex curved surface 115.

As illustrated in FIG. 9, the handle according to the invention comprises a compression part 140 extending the fixing part 130 and intended to bear against the deformable coating blade 200 when the latter is fixed to the coating knife handle.

The compression part 140 comprises a first flat bearing surface 141 extending in the reference plane X-X on one side of which the compression part is located and on the other side of which the blade is located when the latter is fixed to the coating knife handle.

According to one embodiment of the invention, the fixing part 130 has, in the extension of the concave bearing face 122, a fixing heel 131 secant with the reference plane X-X. In other words, the fixing heel 131 extends on either side of the reference plane X-X.

The fixing heel 131 comprises a second flat fixing surface 132 for fixing the blade arranged in such a way that the first flat surface 141 and the second flat surface 132 form an open angle β between them, less than 179.9°, preferably less than 179.5°, advantageously between 177 and 179.5°.

This embodiment is particularly economical, because it allows use of a flat blade, and is therefore economical to manufacture, while ensuring perfect pressing of the blade against the compression part 140 when the coating knife is assembled.

In fact, the coating knife that is thus obtained comprises a coating knife handle according to the invention and a constrained flat blade fixed against the second flat fixing surface 132 borne by the heel, and pressed by force against the first flat bearing surface 141 of the compression part 140.

In the embodiment illustrated, the second flat fixing surface 132 is arranged in a fixing slit 133 for fixing the blade 200 borne by the heel 131. The slit 133 is delimited by the second flat fixing surface 132 above the blade 200, and by a fixing tongue 134 which constrains the blade 200 against the compression part 140 when the coating knife is assembled.

The fixing slit 133 also comprises a longitudinal groove 135, extending in the longitudinal direction L. Complementing this, the blade comprises reliefs intended to be inserted into the groove 135 to block the blade against the handle 100.

In a first embodiment, these reliefs are spring tabs (not illustrated) obtained by localized stamping of the blade and which flatten when the blade 200 is inserted into the fixing slit 133 at right angles to the longitudinal direction L, and then are released into the longitudinal groove 135 to block the blade. To remove the latter, it is simply a matter of strongly forcing the blade away from the handle at right angles to the longitudinal direction L.

Alternatively, these reliefs are non-deformable and the blade is inserted/removed laterally with respect to the handle, that is to say in the longitudinal direction.

According to other embodiments of the invention:
the handle can have stiffening reinforcements inside the profile;
the profile of the handle can be manufactured by extrusion then cut to the width of the blade to spread the pressure over all of this width;
the handle can form part of an assembly also comprising a fixing part for fixing an extension handle to this handle, the fixing part having a form complementing the engagement 112 and lever 113 zones of the handle to be able to attached to the handle;
the assembly can also comprise an extension handle provided with said fixing part to allow coating to be applied at height or at a distance from the user.

1. A coating knife handle (100) composed of a profile extending along a longitudinal direction and comprising a gripping part (110) linked by a central part (120) to a fixing part (130) for fixing an edge of a coating blade (200), wherein the gripping part (110) has a convex top face (111) intended to receive the palm and the fingers of the hand of the user, characterized in that the convex curved top face (111) is linked to the central part (120), on the one hand:
by an engagement zone (112) comprising a front convex curved engagement face (114), against which the fingers of the user can fold, and linked directly to a concave curved engagement face (121) situated at the front of the central part (120), the convex top face (111) being linked to the central part (120), and on the other hand,
by a lever zone (113) comprising a convex bottom lever face (115) situated under the convex top face (111), against which the thumb of the user can fold in the direction of the joint, and linked by a switchback zone (117) to a concave bearing face (122) situated behind the central part (120).

2. The coating knife handle (100) as claimed in claim 1, wherein the convex top face (111) has a main radius of curvature (R1) of between 9 and 11 cm, preferably 10 cm.

3. The coating knife handle as claimed in claim 1, wherein the convex bottom lever face (115) has a radius of curvature (R2) of between 7 and 9 cm, preferably 8 cm.

4. The coating knife handle (100) as claimed in claim 1, wherein the front convex curved engagement face (114) and the concave curved engagement face (121) have a radius of curvature (R3-R4) of between 0.8 and 1.2 cm.

5. The coating knife handle as claimed in claim 1, wherein the concave bearing face (122) has a radius of curvature (R5) of between 2.4 and 2.8 cm, preferably 2.6 cm.

6. The coating knife handle as claimed in claim 1, wherein the switchback zone (117) has a convex curved switchback face (117a) having a radius of curvature (R6) of between 0.2 and 0.6 cm, preferably 0.4 cm.

7. The coating knife handle as claimed in claim 1, wherein the convex top face (111) is linked to the convex bottom lever face (115) by a convex curved bearing face (116) having a radius of curvature (R7) of between 0.6 and 0.9 cm, preferably 0.75 cm.

8. The coating knife handle as claimed in claim 1, wherein, seen in cross-section of the handle, the gripping part has a median plane (P1), passing through a middle of the front convex curved engagement face (114) and a middle of the rear convex curved bearing face (116), the median plane (P1) forming an angle (a) with the reference plane (X-X).

9. The coating knife handle (100) as claimed in claim 1, wherein the fixing part (130) is extended by a compression part (140) intended to bear against the deformable coating blade when the latter is fixed to the coating knife handle, the compression part (140) comprising a first flat bearing surface (141) extending in a reference plane (X-X) on one side of which the compression part (140) is located and on the other side of which the blade (200) is located when the latter is fixed to the coating knife handle, and wherein the fixing part (130) has, furthermore, a fixing heel (131) secant with the reference plane (X-X) and comprising a second flat fixing surface (132) for fixing the blade, the first and the second flat surfaces (141-132) forming an open angle (β) between them, less than 179.9°, preferably less than 179.5°, advantageously between 177 and 179.5°.

10. A coating knife, characterized in that it comprises a coating knife handle as claimed in claim 9, and a constrained flat blade fixed by force against the second flat fixing surface borne by the heel, and pressed by force against the first flat bearing surface of the compression part.

11. An assembly comprising a handle as claimed in claim 1 and a fixing part for fixing an extension handle to this handle, characterized in that the fixing part has a form complementing the engagement and lever zones of the handle to be able to be attached to the handle.

12. The assembly as claimed in claim 11, comprising an extension handle provided with said fixing part.
